(19) United States
(12) Patent Application Publication
(10) Pub. No.: US 2026/0250095 A1
(43) Pub. Date: Aug. 27, 2026

(54) BLANK JOINING MODULE WITH IMPROVED ERGONOMICS

(71) Applicant: BOBST MEX SA, Mex (CH)

(72) Inventor: Bryan CARDOSO, Pully (CH)

(73) Assignee: BOBST MEX SA, Mex (CH)

(21) Appl. No.: 18/874,852

(22) PCT Filed: Jun. 29, 2023
(86) PCT No.: PCT/EP2023/067904

§ 371 Date: Dec. 13, 2024

(30) Foreign Application Priority Data
Jun. 30, 2022 (EP) 22182213.3

(51) Int. Cl. B65H 37/04; B31B 50/04; B31B 50/06

(52) U.S. Cl. CPC B65H 37/04; B31B 50/04; B31B 50/06

(57) ABSTRACT

The present invention relates to a feeder module for a blank joining module, the feeder module comprising an upper feeder device and a lower feeder device, each feeder device comprising a loading surface configured to receive a stack of blanks and each feeder device being configured to discharge the blanks one by one in a direction of transportation, and wherein the upper feeder device is displaceable in the direction of transportation such that the upper loading surface is horizontally offset in relation to the lower loading surface.

### FIELD OF THE INVENTION

The present invention relates to a converting machine for producing folding boxes and similar packaging containers. In particular, it relates to blank joining module configured to join two blanks before folding the blanks in unison.

### BACKGROUND

Converting machines such as folder-gluers are used in the production of packaging items such as paperboard and cardboard boxes. These machines comprise a plurality of workstations which may fold and glue blanks to form boxes and then count, stack and condition the boxes into batches.

Folder-gluer machines can be configured to produce many different types of folding boxes and packaging containers. One type of box which is composed from two blanks joined together is often referred to as a “shelf-ready” box. The shelf-ready box comprises an outer blank and an inner blank folded and glued together. The inner blank may serve as an inner container for the item to be stored, while the outer blank may serve as protection during transportation. This type of box is frequently used in supermarkets and shops, where the inner container is placed on a shelf with the items left inside.

When producing packaging containers from several blanks joined together, a blank joining module with a double feeder is needed. Specifically, a first and a second blank each need a dedicated feeder. An example of a blank joining module comprising an upper feeder and a lower feeder is described in document EP2072241.

For large work batches, the machine operator needs to continuously load new blanks in the form of stacks into the upper and lower feeders. It is especially difficult for a machine operator to access the upper feeder when the blanks in the lower feeder have a significant horizontal length in the direction of transportation of the blanks.

### SUMMARY

In view of the prior art, it is an object of the present invention to provide a blank joining module with facilitated access to the feeders.

According to a first aspect of the present invention, there is provided a blank joining module for a converting machine, the blank joining module comprising a chassis, an upper feeder device having an upper loading surface and a lower feeder device having a lower loading surface, each feeder device being configured to receive a stack of blanks and to discharge the blanks one by one in a direction of transportation, and wherein the upper loading surface of upper feeder device is displaceable in the direction of transportation such that the upper loading surface is horizontally offset in relation to the lower loading surface.

The present invention is based on a realization that an upper feeder device with a displaceable loading surface provides an improved lateral access to the upper feeder, and the access can be optimized for different formats of upper and lower blanks.

The direction of transportation is in the horizontal direction. The direction of transportation extends between an inlet and an outlet of the converting machine. The upper blank has an inclined direction of transportation and the lower blank has a horizontal direction of transportation.

The horizontal direction of transportation of the lower blank may comprise a deviation of 0 to 15 degrees from the horizontal plane. The direction of transportation of the upper feeder device comprises a vertical and a horizontal direction component. When the upper loading surface is displaced, a horizontal displacement component in the direction of transportation is performed. However, due to the inclined transportation path, the upper feeder device is also vertically displaced. The horizontal displacement component of the upper loading surface thus enables the upper loading surface to be displaced upstream and downstream in the direction of transportation.

Horizontally offset means that the upper loading surface of the upper feeder device can be positioned further upstream in the direction of transportation than the loading surface of the lower feeder device. This means that a rear edge of the upper loading surface can be positioned such that is horizontally offset with a rear edge of the lower loading surface. However, if the upper and lower blanks are provided with different lengths in the direction of transportation, this allows to vertically align a rear edge of the stack in the upper feeder device with a rear edge of the stack in the lower feeder device. The upper loading surface can be moved upstream and downstream in the direction of transportation. As the machine operator loads the upper and lower loading surfaces from an upstream position, the upper loading surface can thus be moved closer to the machine operator.

In an embodiment, the blank joining module further comprises an upper alignment device connected to the upper feeder device, wherein the upper alignment device is provided with a variable length and wherein the upper feeder device is connected to the upper alignment device. Preferably, there is a fixed connection between the upper feeder device and the upper alignment device.

In an embodiment, the upper alignment device comprises an upper pressing member and an upper conveyor belt configured to receive a blank therebetween, the upper pressing member and the upper conveyor belt being supported by a common support structure, wherein the support structure comprises an expandable and retractable connection mechanism configured to allow the longitudinal lengths of the upper pressing member and the upper conveyor belt to be modified in unison and to the same distance.

In an embodiment, the longitudinal lengths of the upper pressing member and the upper conveyor belt are modified upon a longitudinal displacement of the upper feeder device.

In an embodiment, the connection structure comprises a plurality of frame members interconnected by pivot links, and wherein the pivot links are configured to distribute a displacement of the upper feeder device into an equidistant displacement between the frame members.

In an embodiment, the frame members comprise a first cantilevered extension and a second cantilevered extension, and wherein the first cantilevered extension is connected to a pressing roller of the upper pressing member and the second cantilevered extension is connected to a guiding roller configured to maintain the shape of the upper conveyor belt.

In an embodiment, the feeder module comprises a slide rail connection located between the upper feeder device and the chassis.

In an embodiment, the blank joining module further comprises a control circuitry and a displacement motor, wherein the control circuitry is configured to determine a required longitudinal position of the upper feeder device based on the longitudinal length of the lower blanks in the lower feeder device, and wherein the displacement motor is configured to automatically displace the upper feeder device to a horizontally offset position in relation to the lower feeder device.

In an embodiment, the blank joining module further comprises an adjustable podium which is attached to the chassis and is movable in the direction of transportation, and wherein the podium comprises at least a first stepping surface which is movable between an extended position located in front of the feeder devices and a retracted position in which the at least one stepping surface is located under the feeder devices.

In an embodiment, the podium further comprises a second stepping surface, and wherein the second stepping surface is connected to the first stepping surface in a slide rail connection, and wherein the second stepping surface is movable in a perpendicular direction in relation to the direction of transportation.

In an embodiment, the podium is locked in the extended configuration upon activation of a locking mechanism.

In an embodiment, the locking mechanism is manually activated by a press-button, and wherein the locking mechanism is automatically actuated when the press-button is released.

In an embodiment, the podium is connected to a drive motor allowing the operator to extend and retract the podium with an automatic displacement from the drive motor.

### BRIEF DESCRIPTION OF THE DRAWINGS

The invention will now be described with reference to the appended drawings, in which like features are denoted with the same reference numbers and in which:

FIG. 1 is a schematic view of a converting machine in the configuration of a folder gluer;

FIG. 2a is schematic perspective view of a folding box in the configuration of a shelf-ready box;

FIG. 2b is a planar view of composed blank for producing the folding box of FIG. 2a;

FIG. 3a is a schematic perspective view of a blank-joining module according to an embodiment of the present invention;

FIGS. 3b and 3c are schematic cross-sectional detailed views of a podium for the blank joining module of FIG. 3a;

FIG. 4 is a cross-sectional view of the blank-joining module of FIG. 3a;

FIG. 5 is a schematic cross-sectional view of a feeder unit according to an embodiment of the present invention;

FIG. 6 is a schematic cross-sectional view of a lower alignment device of the blank joining module;

FIGS. 7a and 7b are schematic cross-sectional views of an upper alignment device of the blank joining module from a first side and from a second side, respectively; and

FIG. 7c is a schematic perspective view of the upper alignment device of FIGS. 7a and 7b.

### DETAILED DESCRIPTION

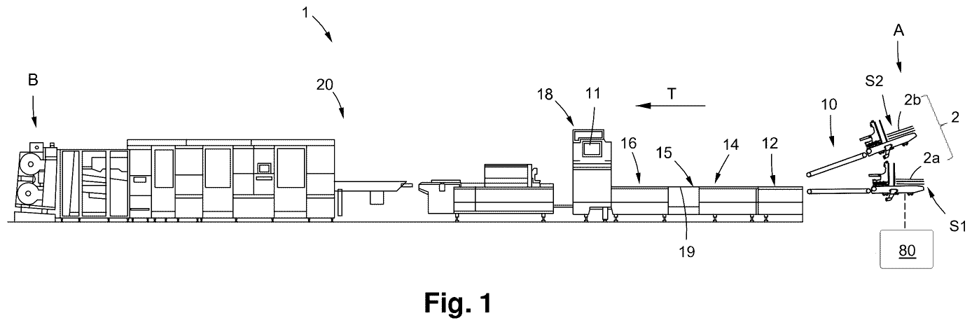

Referring to the figures and in particular to FIG. 1 which illustrates a converting machine 1 in the form of a folder-gluer machine 1. The folder-gluer machine 1 is configured to receive an upper and lower stacks S2, S1 of blanks 2, join the blanks and then fold and glue them together to form folding boxes 2″ or other composed packaging containers.

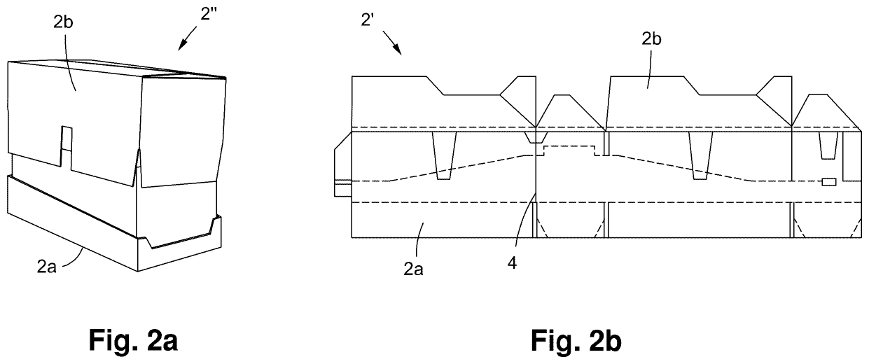

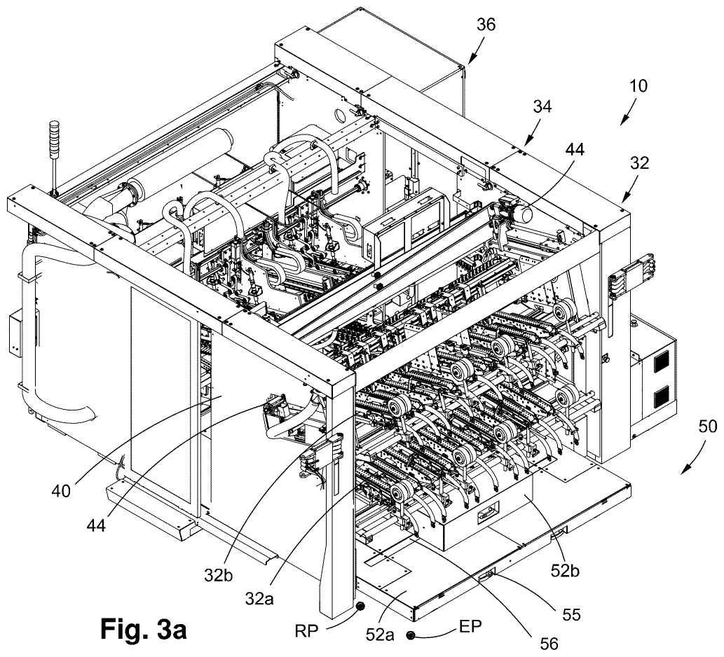

There are several types of folding boxes 2′ and packaging containers which can be produced in a folder-gluer machine 1. One type of box 2″ is illustrated in FIG. 2a and may be referred to as “shelf-ready” box 2′. As illustrated in FIG. 2b, this type of box 2′ is composed from two blanks 2b, 2a joined together. One blank 2a may form an inner container and the other blank 2b may form an outer container. In use, the outer container can be manually removed while the inner container is still holding the items to be stored.

This type of a composed folding box 2″ is produced by first forming a composed blank 2′ from a first blank 2a and a second blank 2b in the folder-gluer machine 1. Subsequently, the composed blank 2′ undergoes a folding and gluing operation.

As illustrated in FIG. 1, the present folder-gluer machine 1 comprises a series of different workstations in the form of modules. The modules may include, in the direction of transportation T extending from an inlet A to an outlet B: a blank joining module 10, a fold pre-breaking module 12, a gluing module 15 and a folding module 16. The folder-gluer machine 1 may further comprise a main user interface 11 and a quality control system 18. After the gluing and folding modules, a delivery module and conditioning section 20 can be provided in order to count and separate a shingled stream of folding boxes 2′ into separate batches. The converting machine 1 further comprises a conveyance system 19 comprising conveyors such as endless belts and rollers configured to transport the first and second blanks 2a, 2b in a direction of transportation T. The converting machine 1 also comprises a control circuitry 80 configured to control the operation of the blank-joining module 10.

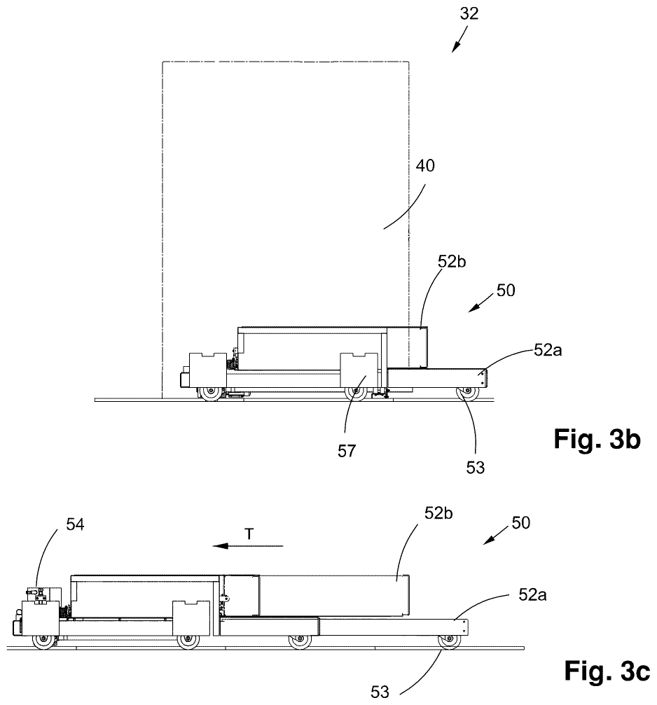

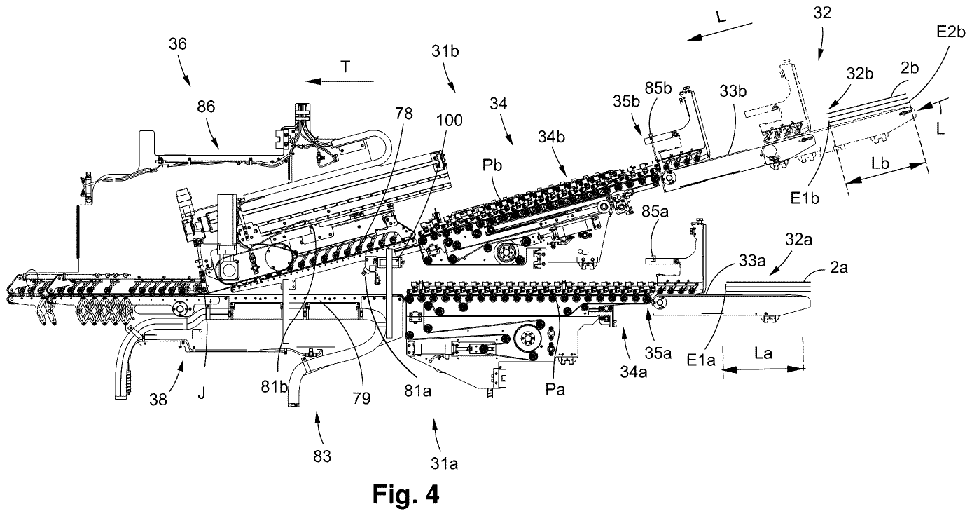

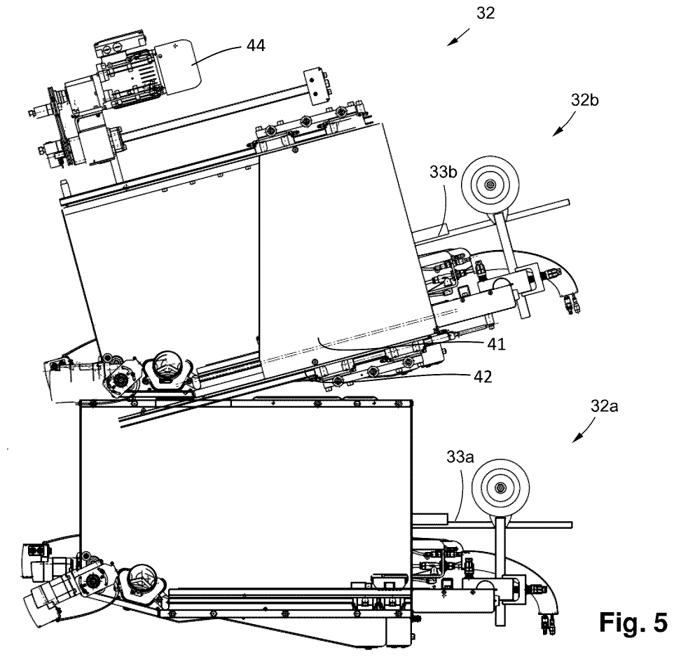

The blank joining module 10 enables the folder-gluer 1 to produce the composed blank 2′. As illustrated in FIGS. 3a and 4, the blank joining module 10 comprises a feeder unit 32, an alignment unit 34, a gluing device 100, a register control arrangement 36, and a joining transfer 38.

The feeder unit 32 comprises a lower feeder device 32a and an upper feeder device 32b. The upper and lower feeder devices 32b, 32a are configured to respectively feed the blanks 2a, 2b one by one in the direction of transportation T.

The upper feeder device 32b is configured to feed a first blank 2b, also referred to as an “upper blank” 2b, from a stack S2 positioned on an upper loading surface 33b. The lower feeder device 32a is configured to feed a second blank 2a, also referred to as a “lower blank” 2a from a stack S1 positioned on a lower loading surface 33a in the lower feeder device 32a.

The upper loading surface 33b is located vertically above the lower loading surface 33a. To facilitate the access to the upper loading surface 33b, the loading surface 33b of the upper feeder device 32b can be displaceable in a longitudinal direction L and thus in the direction of transportation T of the upper blank 2b. The longitudinal direction L is defined by the longitudinal extension of the upper loading surface 33b. The longitudinal direction L is thus downwardly sloping in the direction of transportation T.

The upper loading surface 33b can be displaced into a horizontally offset position in relation to the lower loading surface 33a. This may allow the rear edge of the blanks 2b on the upper loading surface 33b to be vertically aligned with the rear edge of the blanks 2a on the lower loading surface 33a. Alternatively, the rear edge of the upper blanks 2b can be moved further upstream in the direction of transportation T such that a horizontal distance between the rear edge of the upper blank 2b and the rear edge of the lower blank 2a is reduced. In such a way, the upper loading surface 33b can be positioned closer to the machine operator.

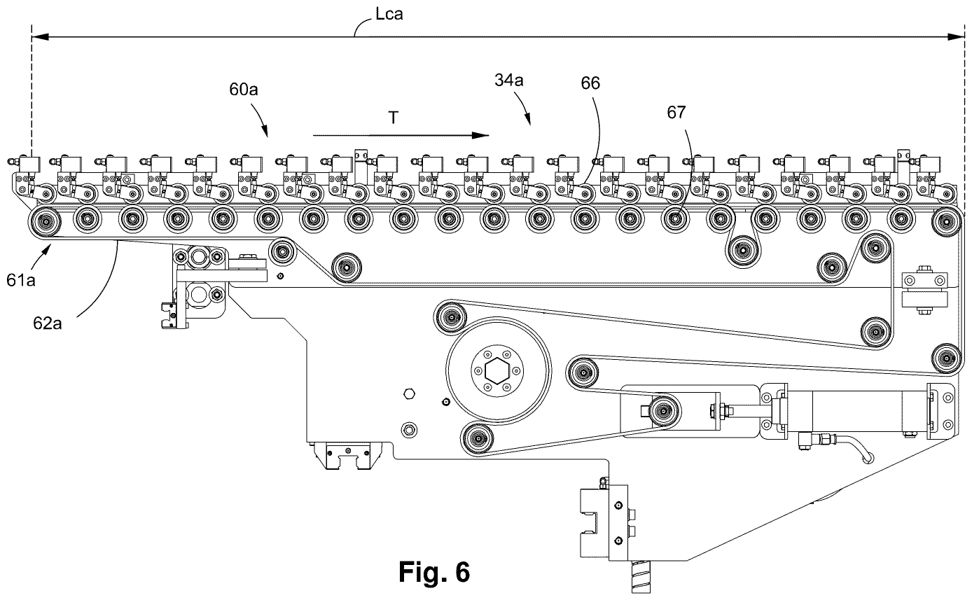

As best seen in FIGS. 3a, 4 and 5, the upper feeder device 32b is slidably mounted to a chassis (i.e. a structural frame) 40 of the blank joining module 10. The connection between the upper feeder device 32b and the chassis 40 may be achieved with a sliding connection. The sliding connection may comprise a slide rail 42 and a slider 41. The upper feeder device 32b can be displaced along the slide rail 42 by a motor 44.

The motor 44 may perform an automatic displacement of the upper feeder device 32b. The control circuitry 80 of the blank joining module 10 may automatically operate the motor 44 to displace the upper feeder device 32b to a predetermined operating position calculated from the longitudinal length La of the lower blank 2a in the lower feeder device 32a. The longitudinal length La is the length of the lower blank 2a in the direction of transportation T. Preferably, the upper feeder device 32b is displaced such that the rear edges (in the direction of transportation T) of the upper and lower stack of blanks 2 in the respective feeder devices 32a, 32b are vertically aligned. Alternatively, the upper feeder device c32b an be displaced based on manual input into the main user interface 11. In such a way, an operator can decide on the position of the upper feeder device 32b.

As illustrated in FIG. 4, the alignment unit 34 is arranged downstream in the direction of transportation T of the feeder unit 32. The alignment unit 34 is configured to laterally align the upper blank 2b and the lower blank 2a to their respective predefined lateral positions. The predetermined lateral positions are defined by the position of the longitudinal crease lines 4 and the position of folding tools in the converting machine 1. The predetermined lateral positions thus enable the composed blank 2′ to be positioned according to assembly instructions and such that the converting machine 1 folds the composed blank 2′ in the crease lines 4.

Hence, the alignment unit 34 is configured to align the upper and lower blanks 2b, 2a in a direction perpendicular to the direction of transportation T. In such a way, the upper blank 2b and the lower blank 2a are in the correct lateral positions when the blanks 2a, 2b are brought into contact with each other in a junction point J.

The gluing device 100 is located upstream of the junction point J. The gluing device 100 is arranged to dispense glue on the top side of the lower blank 2a such that the glue is positioned in-between the upper blank 2b and the lower blank 2a when they are brought into contact with each other.

The alignment unit 34 comprises an upper alignment device 34b configured to align the upper blank 2b and a lower alignment device 34a configured to align the lower blank 2a. The upper and lower alignment devices 34b, 34a are provided with a respective distal upstream connection end 35b, 35a which is preferably fixedly connected to the upper and lower feeder devices 32b, 32a.

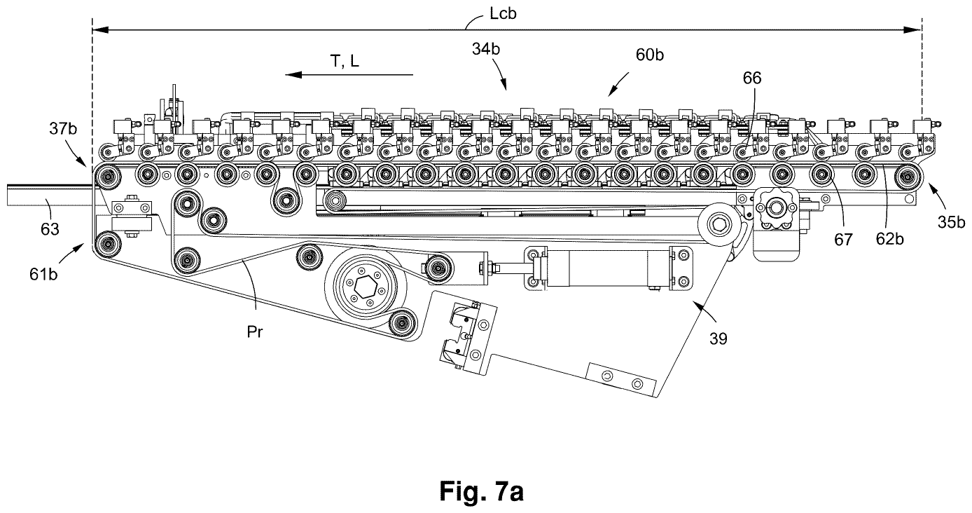

The lower alignment device 34a is configured to transport the lower blank 2a along a substantially horizontal transportation path Pa. The horizontal transportation path may thus deviate between 0 and 15 degrees in relation to the horizontal plane. As best seen in FIG. 6, the lower alignment device 34a comprises an upper pressing member 60a, a lower conveyor 61a and a guide (not shown). The lower conveyor 61a comprises an endless conveyor belt 62a having a contact length Lca configured to be in contact with and drive the lower blank 2a forward in the direction of transportation T.

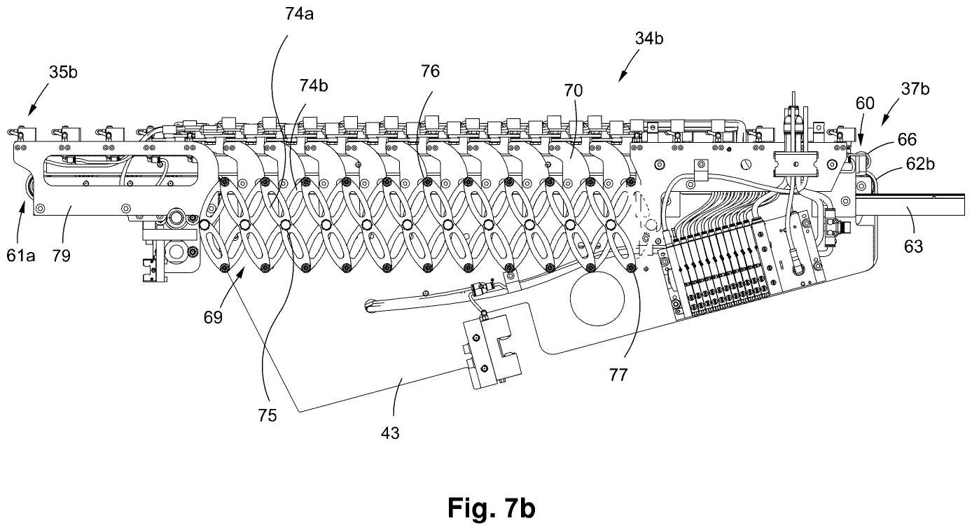

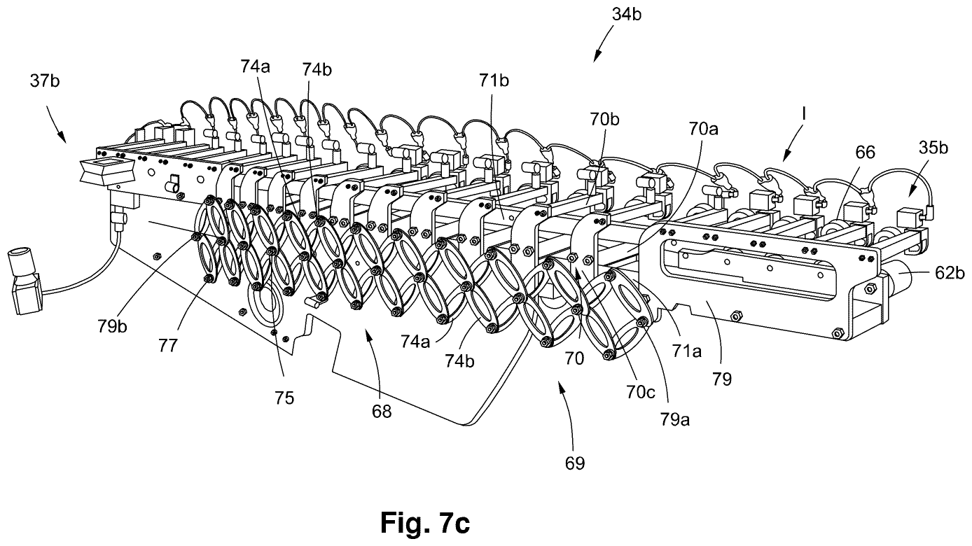

As best seen in FIGS. 7a to 7c, the upper alignment device 34b comprises an upper pressing member 60b, and an upper conveyor 61b. The upper conveyor 61b comprises an endless upper conveyor belt 62b having a contact length Lcb configured to be in contact with and drive the upper blank 2b forward in the direction of transportation T. A guide 63 is arranged with its longitudinal extension coinciding with the direction of transportation T. The upper pressing member 60b and the upper conveyor 61b are arranged at an angle in relation to the direction of transportation T such as to direct a lateral edge of the lower blanks 2a against the guide 63.

The upper alignment device 34b is thus configured similarly to the lower alignment device 34a. However, the upper alignment device 34b is provided with a variable contact length Lcb in the direction of transportation T. The upper alignment device 34b may further comprise a compensation mechanism 39 in a return path Pr of the upper conveyor belt 62b. The compensation mechanism 39 is configured to change the length of the upper endless conveyor belt 62b in the return path such as to accommodate for the change in the contact length Lcb.

The upper alignment device 34b comprises a mobile distal end 35b connected to the upper feeder device 32b and a fixed distal end 37b connected to the chassis 43 of the alignment device 34b. The mobile distal end 35b is thus movable in the direction of transportation of the upper blank 2b. The chassis 43 of the upper alignment device is connected to the chassis of the blank-joining module 10. This allows the displacement of the upper feeder device 32b in the longitudinal direction L while maintaining a fixed connection to the upper alignment device 34b.

As illustrated in FIGS. 7b and 7c, the upper conveyor 61b of the upper alignment device 34b further comprises a support structure 69 configured to support the upper conveyor belt 62b. The support structure 69 comprises a plurality of guiding rollers 67 (see FIG. 7a) onto which the upper conveyor belt 62b is mounted. The guiding rollers 67 are attached to frame members 70. A connection mechanism 68 is connecting adjacent frame members 70 to each other. The connection mechanism 68 is expandable such that the distance between the frame members 70 can be modified. The frame members 70 are displaceable in the direction of transportation T. Each guiding roller 67 is attached to a frame member 70 and arranged in a line. The connection mechanism 68 permits a modification of the contact length Lcb, while all guiding rollers 67 remain in contact with the upper blanks 2b. The contact length Lcb can be varied between a retracted position Lcb_min in which the connection mechanism 68 has its shortest length and an expanded position in which the connection mechanism 68 has its longest length Lcb_max.

Preferably, the connection mechanism 68 comprises a plurality of pivotable links 74a, 74b which allow an equidistant displacement of the frame members 70. The pivotable connection links 74a, 74b can be provided by two linear elements. The pivotable connection links 74a, 74b are connected to each frame member 70 in a central pivot 75. The pivotable connection links 74a, 74b are also connected to each other in an upper pivot 76 and a lower pivot 77. The upper pivot 76 and the lower pivot 77 are movable in the longitudinal direction L.

By connecting the frame members 70 to the central pivot 75, the horizontal position of the central pivot 75 is kept constant.

The support structure has a first distal end 35b connected to the upper feeder device 32b and a second distal end 37b connected to the chassis 40 of the blank joining module 10.

As best seen in FIG. 7c, each frame member 70 comprises a first cantilevered extension 70a, a second cantilevered extension 70b, and a frame member bracket 70c to which the first and second cantilevered extensions are connected.

The guiding rollers 67 of the upper conveyor belt 62b are attached to the first cantilevered extension 70a, and pressing rollers 66 are attached to the second cantilevered extension 70b. The upper blank 2b is received between the pressing rollers 66 and the upper conveyor belt 62b. The first and second cantilevered extensions 70a, 70b extend horizontally and parallel in relation to each other. The second cantilevered extension 70b is arranged vertically above the first cantilevered extension 70a.

The second cantilevered extension 70b may be supported by an upper guide rail 71b and the second cantilevered extension 70b may be supported by a lower guide rail 71a. The guide rails 71a, 71b may be in the form of longitudinal bars arranged underneath the first and second cantilevered extensions 70a, 70b, respectively.

The distal inlet end 35b of the upper alignment device 34b may comprise an attachment bracket 79 configured to be attached to the upper feeder device 32b. The attachment bracket 79 may further provide a fixed structure to form an inlet section I for the upper pressing rollers 66 and guiding rollers 67 of the conveyor belt 62b. The attachment bracket 79 provides a fixed connection to the cantilevered extensions 70b, 70c such that the inlet section I has a constant length, regardless of the extension or retraction of the connection mechanism 68. This can ensure that there is a sufficiently long inlet section I into the upper alignment device 34b such that the upper blank 2b has completely exited the upper feeder device 32b before the upper blank 2b is obliquely aligned against the guide 63. A distal central pivot 79a is attached to the attachment bracket 79. A second distal central pivot 79b is attached to a frame member 77 of the upper alignment module 34b.

To further facilitate the access to the upper feeder device 32b, the blank joining module 10 may comprise a modular podium 50. As best seen in FIGS. 3a to 3c, the podium 50 comprises at least a first stepping surface 52a. Preferably the podium 50 further comprises a second stepping surface 52b located on top of the first stepping surface 52a.

The second stepping surface 52b may preferably be smaller than the first stepping surface 52a. The second stepping surface 52b may be connected on the first stepping surface 52a via a slide rail connection 56. The first stepping surface 52a is movable in the direction of transportation T and the second stepping surface 52b is movable in a direction which is a perpendicular to the direction of transportation T.

The first stepping surface 52a is provided with displacement means 53 such that it can be displaced between a retracted position RP (see FIG. 3a), located under the converting machine 1, and an extended position EP located in front of the converting machine 1. The displacement means 53 may be in the form of rollers or a slide rail. In the extended position EP, the first stepping surface 52a and the second stepping surface 52b are positioned such that an operator can stand upon the first and second stepping surfaces 52a, 52b and more easily access the loading surface 33b of the upper feeder device 32b. Preferably, the first stepping surface 52a and the second stepping surface comprise a locking mechanism 57. This allows the first and second stepping surfaces 52a, 52b to be locked in the extended position EP and reduce the risk of unintentional movement.

The first stepping surface 52a may be connected to a drive mechanism comprising a displacement motor 54. The displacement means 53 and the drive mechanism are attached to the structural frame 40 of the blank joining module 10.

An manual displacement of the first stepping surface 52a may be initiated by activating a press button 55 located on a handle of the modular podium 50. Alternatively, the first and second stepping surfaces 52a, 52b can be automatically displaced between the retracted and extended positions based on information from the control circuitry 80.

The modular podium 50 may cooperate with the upper extendable upper feeder device 32b. The upper feeder device 32b provides an improved horizontal access to the upper feeder device, while the podium provides an improved vertical access to the upper feeder device 32b.

1. A blank joining module for a converting machine, the blank joining module comprising:
a chassis,
an upper feeder device having an upper loading surface, and
a lower feeder device having a lower loading surface,
the upper feeder device being configured to receive a stack of upper blanks and the lower feeder device being configured to receive a stack of lower blanks,
the upper feeder device and the lower feeder device being configured to discharge the upper blanks and lower blanks, respectively, one by one in a direction of transportation, and
wherein the upper loading surface of the upper feeder device is displaceable in the direction of transportation such that the upper loading surface is horizontally offset in relation to the lower loading surface.

2. The blank joining module according to claim 1, further comprising an upper alignment device connected to the upper feeder device, wherein the upper alignment device is provided with a variable length and wherein the upper feeder device is connected to the upper alignment device.

3. The blank joining module according to claim 2,
wherein the upper alignment device comprises an upper pressing member and an upper conveyor belt configured to receive a blank therebetween, the upper pressing member and the upper conveyor belt being supported by a common support structure,
wherein the support structure comprises an expandable and retractable connection mechanism configured to allow the longitudinal lengths of the upper pressing member and the upper conveyor belt to be modified in unison and to the same distance.

4. The blank joining module according to claim 3, wherein the longitudinal lengths of the upper pressing member and the upper conveyor belt are modified upon a longitudinal displacement of the upper feeder device.

5. The blank joining module according to claim 4, wherein the support structure comprises a plurality of frame members interconnected by pivot links, and wherein the pivot links are configured to distribute a displacement of the upper feeder device into an equidistant displacement between the frame members.

6. The blank joining module according to claim 5, wherein the frame members comprise a first cantilevered extension and a second cantilevered extension, and wherein the first cantilevered extension is connected to a pressing roller of the upper pressing member and the second cantilevered extension is connected to a guiding roller configured to maintain the shape of the upper conveyor belt.

7. The blank joining module according to claim 1, further comprising a slide rail connection located between the upper feeder device and the chassis.

8. The blank joining module according to claim 1, further comprising a control circuitry and a displacement motor, wherein the control circuitry is configured to determine a required longitudinal position of the upper feeder device based on the longitudinal length of the lower blanks in the lower feeder device, and wherein the displacement motor is configured to automatically displace the upper feeder device to a horizontally offset position in relation to the lower feeder device.

9. The blank joining module according to claim 1, wherein the blank joining module further comprises an adjustable podium which is attached to the chassis and is movable in the direction of transportation, and wherein the podium comprises at least a first stepping surface which is movable between an extended position located in front of the feeder devices and a retracted position in which the first stepping surface is located under the feeder devices.

10. The blank joining module according to claim 9, wherein the podium further comprises a second stepping surface, and wherein the second stepping surface is connected to the first stepping surface in a slide rail connection, and wherein the second stepping surface is movable in a perpendicular direction in relation to the direction of transportation.

11. The blank joining module according to claim 9, wherein the podium is locked in the extended configuration upon activation of a locking mechanism.

12. The blank joining module according to claim 11, wherein the locking mechanism is manually activated by a press-button, and wherein the locking mechanism is automatically actuated when the press-button is released.

13. The blank joining module according to claim 12, wherein the podium is connected to a drive motor, allowing an operator to extend and retract the podium with an automatic displacement from the drive motor.
